(19) United States
(12) Patent Application Publication
(10) Pub. No.: US 2026/0098587 A1
(43) Pub. Date: Apr. 9, 2026

(54) FLOAT VALVE FOR DOWNHOLE FLOAT EQUIPMENT

(71) Applicant: INNOVEX INTERNATIONAL, INC., Humble, TX (US)

(72) Inventor: Jobby T. Jacob, Humble, TX (US)

(21) Appl. No.: 19/343,046

(22) Filed: Sep. 29, 2025

Related U.S. Application Data
(60) Provisional application No. 63/703,297, filed on Oct. 4, 2024.

(51) Int. Cl. F16K 15/06; E21B 34/06

(52) U.S. Cl. CPC F16K 15/063; E21B 34/06

(57) ABSTRACT

A valve for use in a float collar includes a housing and a plunger positioned at least partially within the housing. The valve also includes a biasing member configured to exert a force on the plunger in an upward direction. The valve also includes a retention member configured to prevent the plunger from moving in the upward direction and forming a seal with the housing when the valve is in a first configuration. The retention member is a spring.

### CROSS-REFERENCE TO RELATED APPLICATIONS

This application claims priority to U.S. Provisional Patent Application No. 63/703,297, filed on October 4, 2024, which is incorporated by reference in its entirety.

### BACKGROUND

A float collar is a component that is installed near the bottom of the casing string during a cementing operation. The float collar typically includes a short length of casing with a check valve therein. The check valve prevents flowback of the cement slurry when pumping is stopped. Without the float collar, the cement slurry placed in the annulus could U-tube, or reverse flow back into the casing.

Conventional check valves used within float collars use ball bearings to hold a plunger in place during transport and casing running operations (e.g., when fluid is flowing upward through the check valve). However, the ball bearings often fall out prematurely. Therefore, what is needed is an improved check valve for a float collar.

### SUMMARY

A valve for use in a float collar is disclosed. The valve includes a housing and a plunger positioned at least partially within the housing. The valve also includes a biasing member configured to exert an upward force on the plunger. The valve also includes a retention member configured to prevent the plunger from moving in an upward direction and forming a seal with the housing when the valve is in a first configuration. The retention member is a spring.

In another embodiment, the valve may include a housing including a cage that defines a first recess in an inner surface thereof. The valve also includes a plunger positioned at least partially within the housing. The plunger includes a shaft that defines a second recess in an outer surface thereof. The valve also includes a biasing member configured to exert an upward force on the plunger. The valve also includes a retention member positioned at least partially within the first and second recesses when the valve is in a first configuration. The retention member is a garter spring that is wrapped around the shaft of the plunger. The retention member is configured to prevent the plunger from moving in an upward direction and forming a seal with the housing when the valve is in the first configuration. The valve is configured to actuate from the first configuration into a second configuration in response to a downward force being exerted on the plunger that exceeds the upward force, thereby causing the plunger and the retention member to move in a downward direction, which removes the retention member from the first and second recesses. The valve is configured to actuate from the second configuration into a third configuration in response to reducing the downward force exerted on the plunger such that it no longer exceeds the upward force, thereby allowing the plunger to move in the upward direction and form the seal with the housing.

A method for operating a valve in a float collar is also disclosed. The method includes running the valve into a wellbore. The valve includes a housing and a plunger positioned at least partially within the housing. The valve also includes a biasing member configured to exert an upward force on the plunger. The valve also includes a retention member configured to prevent the plunger from moving in an upward direction and forming a seal with the housing when the valve is in a first configuration. The retention member is a spring.

### BRIEF DESCRIPTION OF THE DRAWINGS

The present disclosure may best be understood by referring to the following description and accompanying drawings that are used to illustrate embodiments of the invention. In the drawings:

FIG. 1 illustrates a cross-sectional side view of a float valve in a first (e.g., auto-fill) configuration, according to an embodiment.

FIG. 2 illustrates a flowchart of a method for actuating the float valve (e.g., in a float collar), according to an embodiment.

FIG. 3 illustrates a cross-sectional side view of the float valve in a second (e.g., intermediate) configuration, according to an embodiment.

FIG. 4 illustrates a cross-sectional side view showing the float valve in the first and second configurations, according to an embodiment.

FIG. 5 illustrates a cross-sectional side view of the float valve in a third (e.g., standard) configuration, according to an embodiment.

FIG. 6 illustrates another cross-sectional side view of the float valve the first (e.g., auto-fill) configuration, according to an embodiment.

FIG. 7 illustrates a cross-sectional side view of the float valve shown in FIG. 6 in the second (e.g., intermediate) configuration, according to an embodiment.

### DETAILED DESCRIPTION

The following disclosure describes several embodiments for implementing different features, structures, or functions of the invention. Embodiments of components, arrangements, and configurations are described below to simplify the present disclosure; however, these embodiments are provided merely as examples and are not intended to limit the scope of the invention. Additionally, the present disclosure may repeat reference characters (e.g., numerals) and/or letters in the various embodiments and across the Figures provided herein. This repetition is for the purpose of simplicity and clarity and does not in itself dictate a relationship between the various embodiments and/or configurations discussed in the Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the embodiments presented below may be combined in any combination of ways, e.g., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. In addition, unless otherwise provided herein, “or” statements are intended to be non-exclusive; for example, the statement “A or B” should be considered to mean “A, B, or both A and B.”

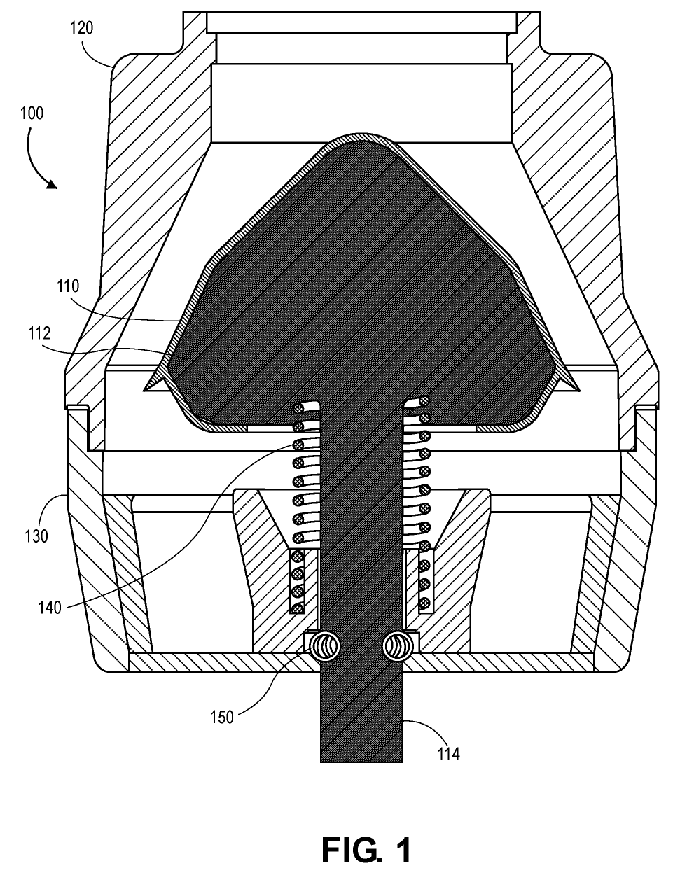

FIG. 1 illustrates a cross-sectional side view of a downhole tool 100 in a first (e.g., auto-fill) configuration, according to an embodiment. The downhole tool 100 may be or include a valve such as a float valve for use within a float collar. The float valve 100 may include a plunger 110. The plunger 110 may include a head 112 and a shaft 114. The head 112 may be positioned above the shaft 114. A diameter of the head 112 may decrease moving in the upward direction. In other words, the head 112 may be conical or frustoconical.

The float valve 100 may also include a cap 120. The plunger 110 (e.g., the head 112) may be positioned at least partially within the cap 120. A diameter of an inner surface of the cap 120 may decrease moving in the upward direction. In other words, the cap 120 may be conical or frustoconical to match with the outer surface of the head 112 of the plunger 110 to facilitate the plunger 110 forming a seal with the inner surface of the cap 120, as described below.

The float valve 100 may also include a cage 130. The cage 130 may be coupled to or integral with the cap 120. The cage 130 may be positioned below the cap 120. The plunger 110 (e.g., the shaft 114) may be positioned at least partially within the cage 130. The cap 120 and the cage 130 may collectively be referred to as a housing.

The float valve 100 may also include a biasing member 140. As shown, the biasing member 140 may be or include a spring. The biasing member 140 may be positioned at least partially around the plunger 110 (e.g., the shaft 114). For example, the biasing member 140 may be helical and have a bore extending therethrough, and the shaft 114 may extend through the bore. The biasing member 140 may be positioned at least partially (e.g., axially) between the head 112 of the plunger 110 and the cage 130. As such, the biasing member 140 may exert an axial (e.g., upward) force on the plunger 110.

The float valve 100 may also include a retention member 150. The retention member 150 may be positioned below the biasing member 140. The retention member 150 may be positioned at least partially around the plunger 110 (e.g., the shaft 114). For example, like the biasing member 140, the retention member 150 may be a helical spring and have a bore extending therethrough. However, the shaft 114 may not extend through the bore. Rather, the retention member 150 may be a garter spring that is wrapped around the shaft 114.

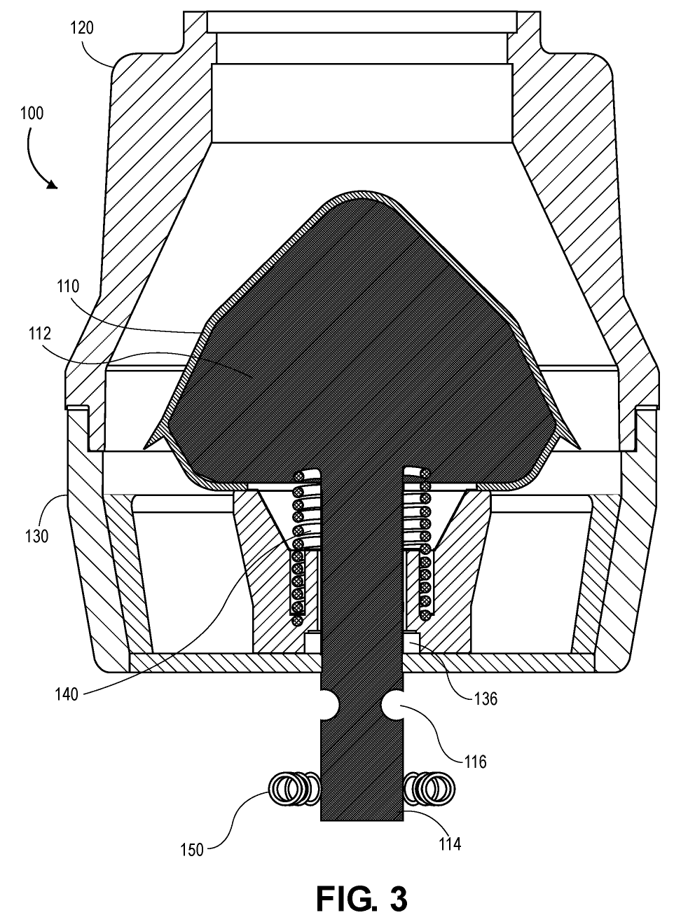

In the first (e.g., auto-fill) configuration, as shown in FIG. 1, the retention member 150 may serve to prevent the plunger 110 from moving upward, which may preserve a flowpath that allows fluid to flow upward and/or downward through the float valve 100. More particularly, in the first (e.g., auto-fill) configuration, the retention member 150 may be coupled to and/or engaged with the plunger 110 and/or the cage 130. For example, the plunger 110 (e.g., the shaft 114) may define a circumferential recess 116 in an outer surface thereof (see FIG. 3), and the retention member 150 may be positioned at least partially in the recess 116. Similarly, the cage 130 may define a circumferential recess 136 in an inner surface thereof (see FIG. 3), and the retention member 150 may be positioned at least partially in the recess 136. In one embodiment, when the retention member 150 is positioned at least partially within the recess 136 of the cage 130, the cage 130 may exert a radially-inward force on the retention member 150. When the retention member 150 is positioned within the recesses 116, 136, the plunger 110 is prevented from moving upward, despite the upward force exerted thereon by the biasing member 140.

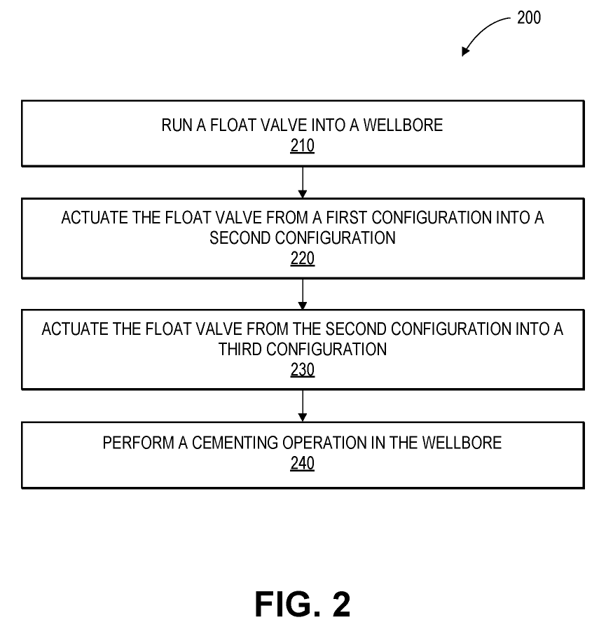

FIG. 2 illustrates a flowchart of a method 200 for actuating the float valve 100 (e.g., in a float collar), according to an embodiment. An illustrative order of the method 200 is provided below; however, one or more steps of the method 200 may be performed in a different order, simultaneously, repeated, or omitted.

The method 200 may include running the float valve 100 into a wellbore, as at 210. This may also or instead include running a float collar (with the float valve 100 therein) into the wellbore. The float valve 100 may be in the first (e.g., auto-fill) configuration (FIG. 1) when it is run into the wellbore.

The method 200 may also include actuating the float valve 100 from the first (e.g., auto-fill) configuration into a second (e.g., intermediate) configuration, as at 220. FIG. 3 illustrates a cross-sectional side view of the float valve 100 in the second (e.g., intermediate) configuration, according to an embodiment. The float valve 100 may be actuated by increasing a downward flow of fluid through the wellbore and the float valve 100 (e.g., using a pump at the surface), which exerts a downward force on the plunger 110. The downward force may exceed the upward force exerted by the biasing member 140, resulting in the plunger 110 moving downward with respect to the cap 120 and the cage 130.

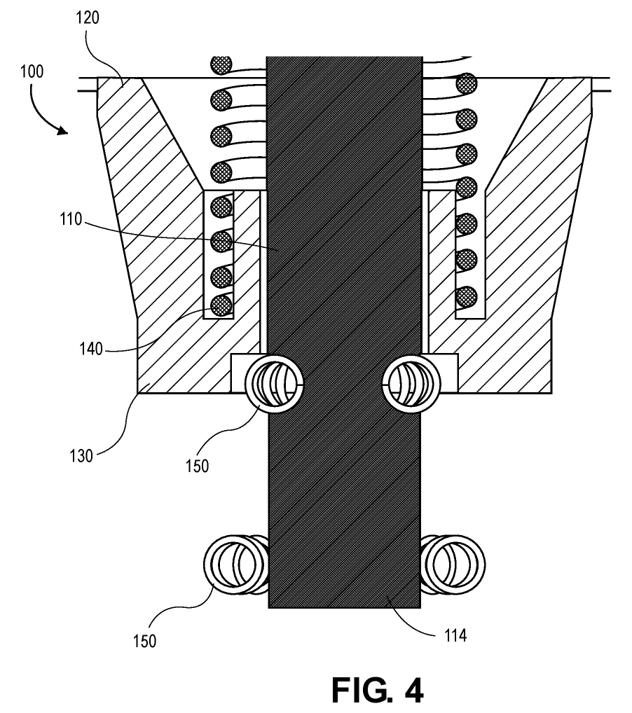

FIG. 4 illustrates a cross-sectional side view showing the float valve 100 in the first and second configurations, according to an embodiment. The downward movement of the plunger 110 with respect to the cage 130 may cause the retention member 150 to be decoupled from and/or disengaged with the plunger 110 (e.g., the shaft 114) and/or the cage 130. For example, the downward movement of the plunger 110 may cause the retention member 150 to be removed from the recess 136 of the cage 130, which may allow the retention member 150 to subsequently expand radially-outward. This expansion may, in turn, cause the retention member 150 to be removed from the recess 116 in the plunger 110 (e.g., the shaft 114).

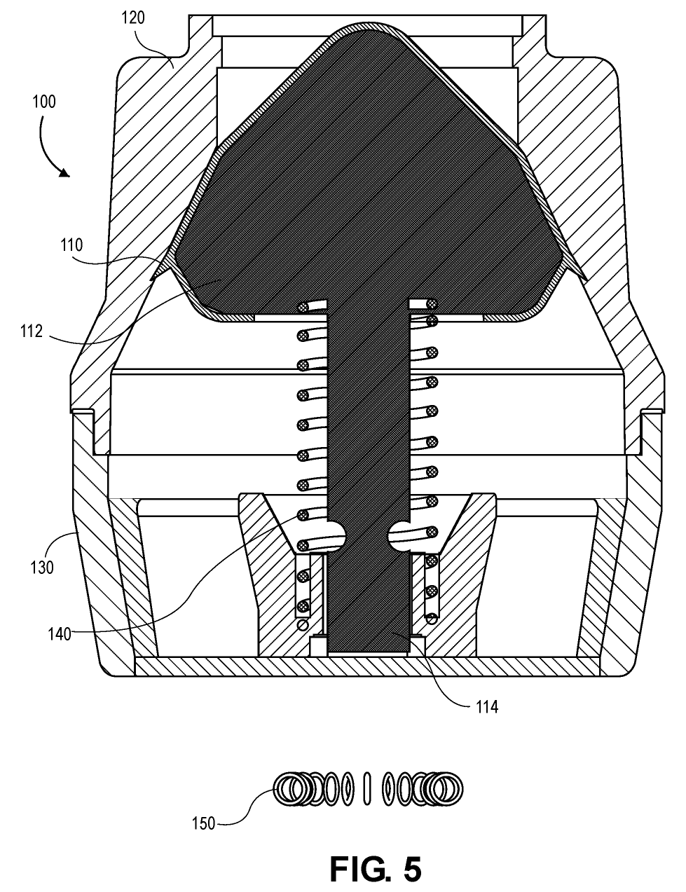

The method 200 may also include actuating the float valve 100 from the second (e.g., intermediate) configuration into a third (e.g., standard) configuration, as at 230. FIG. 5 illustrates a cross-sectional side view of the float valve 100 in the third (e.g., standard) configuration, according to an embodiment. The float valve 100 may be actuated by decreasing the downward flow of fluid through the wellbore and the float valve 100 (e.g., using the pump at the surface), which reduces the downward force on the plunger 110. In response, the upward force exerted by the biasing member 140 may push/move the plunger 110 upward with respect to the cap 120 and the cage 130.

With the retention member 150 no longer coupled to and/or engaged with the plunger 110 (e.g., the shaft 114) and/or the cage 130, the upward force may cause the plunger 110 to contact the cap 120, which may form a seal therewith. The seal may prevent fluid from flowing upward through the float valve 100; however, fluid may still flow downward therethrough if it exerts a force sufficient to overcome the biasing member 140.

The method 200 may also include performing a cementing operation, as at 240. More particularly, once the float valve 100 is in the third (e.g., standard) configuration, a cementing operation may be performed in the wellbore.

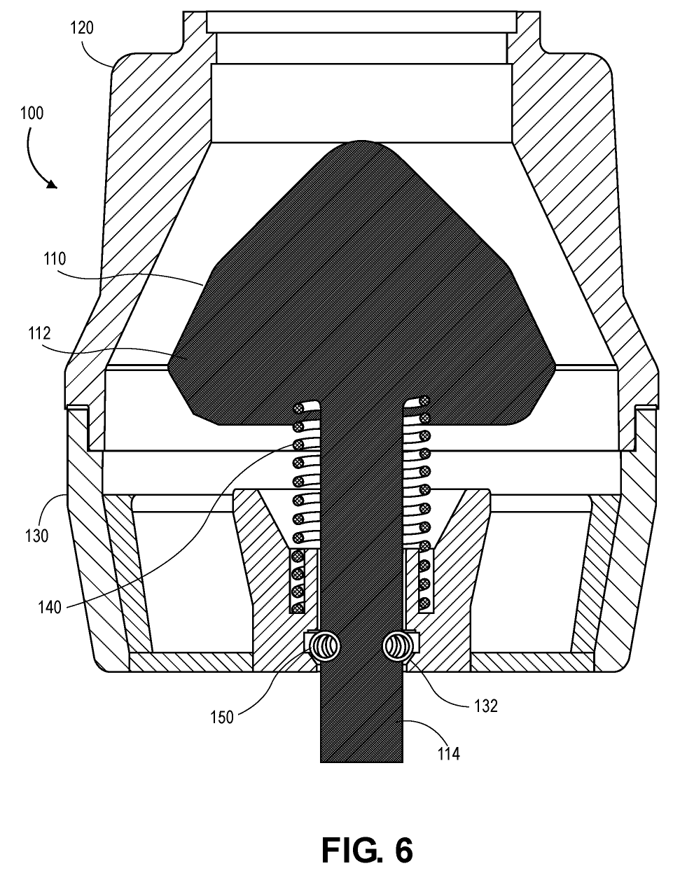

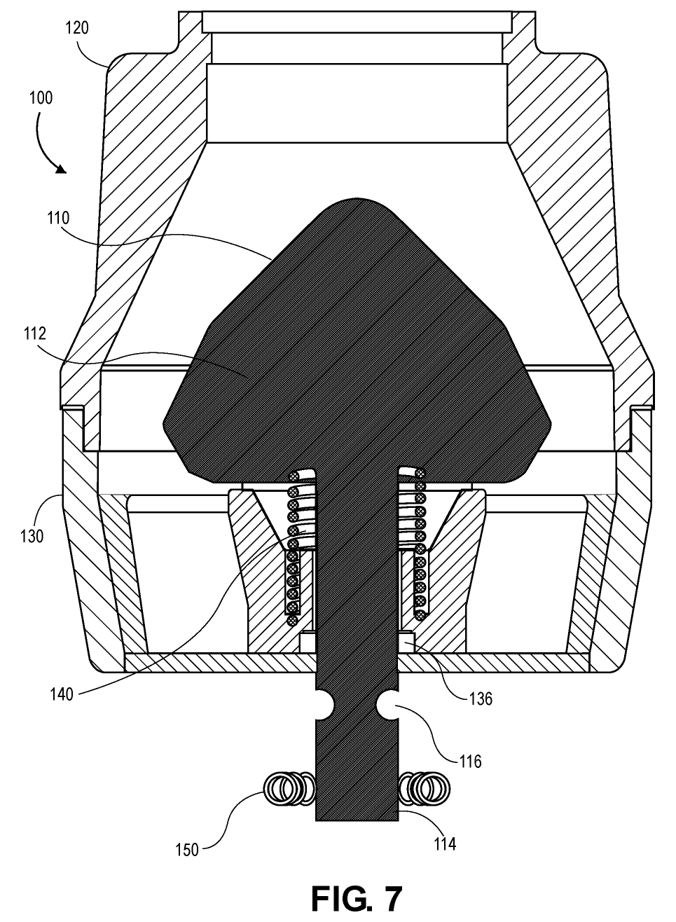

FIG. 6 illustrates another cross-sectional side view of the float valve 100 the first (e.g., auto-fill) configuration, and FIG. 7 illustrates a cross-sectional side view of the float valve 100 shown in FIG. 6 in the second (e.g., intermediate) configuration, according to an embodiment. The cage 130 of the float valve 100 shown in FIG. 6 may be different from the cage 130 of the float valve 100 shown in FIGS. 1 and 3-5. More particularly, the cage 130 of the float valve 100 shown in FIG. 6 may include a lower lip 132 that at least partially defines the recess 136 in which the retention member 150 is positioned. When the float valve 100 is in the first (e.g., auto-fill) configuration, an outer diameter of the retention member 150 may be greater than an inner diameter of the lower lip 132, which may help to retain the retention member 150 within the recess 136 of the cage 130.

In the embodiment of FIGS. 6 and 7, to actuate from the first (e.g., auto-fill) configuration into the second (e.g., intermediate) configuration, the downward force exerted by the fluid must overcome a combination of the upward force exerted by the biasing member 140 + the force needed to compress the retention member 150 radially-inward until it can pass through the lower lip 132. An inner surface of the lower lip 132 may be oriented at an angle with respect to a central (e.g., vertical) longitudinal axis through the float valve 100. The angle may be from about 10 degrees to about 80 degrees, about 20 degrees to about 70 degrees, or about 30 degrees to about 60 degrees. The force to compress the retention member 150 radially-inward until it is small enough to pass through the lower lip 132 may depend upon the angle of the inner surface of the lower lip 132. The force to compress the retention member 150 may also or instead depend upon a spring force of the retention member 150, which may be engineered or selected.

The retention member 150 actuates from the first (e.g., auto-fill) configuration into the second (e.g., intermediate) configuration in response to a predetermined (e.g., critical) downward flow rate. As a result, the retention member 150 in the float valve 100 may be less likely to prematurely actuate (e.g., release the retention member 150) than the conventional valve. The retention member 150 may be designed to have a predetermined load point to actuate/release.

As used herein, the terms “inner” and “outer”; “up” and “down”; “upper” and “lower”; “upward” and “downward”; “above” and “below”; “inward” and “outward”; “uphole” and “downhole”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A valve for use in a float collar, the valve comprising:
a housing;
a plunger positioned at least partially within the housing;
a biasing member configured to exert an upward force on the plunger; and
a retention member configured to prevent the plunger from moving in an upward direction and from forming a seal with the housing when the valve is in a first configuration, wherein the retention member comprises a radially-expandable member.

2. The valve of claim 1, wherein the radially-expandable member comprises a garter spring that is wrapped around a shaft of the plunger.

3. The valve of claim 1, wherein housing comprises a cage that defines a first recess in an inner surface thereof, wherein the plunger comprises a shaft that defines a second recess in an outer surface thereof, and wherein the retention member is positioned at least partially within the first and second recesses when the valve is in the first configuration.

4. The valve of claim 3, wherein the valve is configured to actuate from the first configuration into a second configuration in response to a downward force being exerted on the plunger that exceeds the upward force, thereby causing the plunger and the retention member to move in a downward direction, and wherein the retention member is removed from the first and second recesses in the second configuration.

5. The valve of claim 4, wherein the cage does not include a lower lip that at least partially defines the first recess and compresses the retention member radially-inward as the valve actuates into the second configuration.

6. The valve of claim 4, wherein the cage comprises a lower lip that at least partially defines the first recess, wherein an outer diameter of the retention member is greater than an inner diameter of the lower lip, and wherein the retention member compresses radially-inward to pass through the lower lip as the valve actuates into the second configuration.

7. The valve of claim 6, wherein an inner surface of the lower lip is oriented at an angle with respect to a central longitudinal axis through the valve, and wherein the angle is from about 10 degrees to 80 degrees.

8. The valve of claim 4, wherein the cage exerts a radially-inward force on the retention member when the valve is in the first configuration, and wherein the cage no longer surrounds the retention member and exerts the radially-inward force when the valve in the second configuration, which allows the retention member to expand radially-outward to become removed from the second recess.

9. The valve of claim 8, wherein the valve is configured to actuate from the second configuration into a third configuration in response to reducing the downward force exerted on the plunger such that it no longer exceeds the upward force, thereby allowing the plunger to move in the upward direction and form the seal with the housing.

10. The valve of claim 9, wherein the retention member, once expanded, no longer fits within the first and/or second recesses and does not move in the upward direction together with the plunger.

11. A valve for use in a float collar, the valve comprising:
a housing comprising a cage that defines a first recess in an inner surface thereof;
a plunger positioned at least partially within the housing, wherein the plunger comprises a shaft that defines a second recess in an outer surface thereof;
a biasing member configured to exert an upward force on the plunger; and
a retention member positioned at least partially within the first and second recesses when the valve is in a first configuration, wherein the retention member comprises a garter spring that is wrapped around the shaft of the plunger, wherein the retention member is configured to prevent the plunger from moving in an upward direction and forming a seal with the housing when the valve is in the first configuration, wherein the valve is configured to actuate from the first configuration into a second configuration in response to a downward force being exerted on the plunger that exceeds the upward force, thereby causing the plunger and the retention member to move in a downward direction, which removes the retention member from the first and second recesses, and wherein the valve is configured to actuate from the second configuration into a third configuration in response to reducing the downward force exerted on the plunger such that it no longer exceeds the upward force, thereby allowing the plunger to move in the upward direction and form the seal with the housing.

12. The valve of claim 11, wherein the cage comprises a lower lip that at least partially defines the first recess, wherein an outer diameter of the retention member is greater than an inner diameter of the lower lip, wherein the inner surface of the lower lip is oriented at an angle with respect to a central longitudinal axis through the valve, and wherein the angle is from about 10 degrees to 80 degrees.

13. The valve of claim 12, wherein the downward force to actuate the valve from the first configuration into the second configuration overcomes a combination of (1) the upward force exerted by the biasing member and (2) a force to compress the retention member radially-inward to pass through the lower lip.

14. The valve of claim 11, wherein the retention member, once expanded, no longer fits within the first and/or second recesses, thus enabling the plunger to move upward into the third configuration.

15. The valve of claim 11, wherein the valve does not include ball bearings.

16. A method for operating a valve in a float collar, the method comprising:
running the valve into a wellbore, wherein the valve comprises:
a housing;
a plunger positioned at least partially within the housing;
a biasing member configured to exert an upward force on the plunger; and
a retention member configured to prevent the plunger from moving in an upward direction and forming a seal with the housing when the valve is in a first configuration, wherein the retention member comprises a radially-expandable member.

17. The method of claim 16, further comprising increasing a flow of fluid in the downward direction through the wellbore and the valve using a pump at the surface, which exerts a downward force on the plunger.

18. The method of claim 17, wherein the valve actuates from the first configuration into a second configuration in response to the downward force on the plunger exceeding the upward force on the plunger, and wherein the retention member is removed from the first and second recesses in the second configuration.

19. The method of claim 18, further comprising decreasing or stopping the flow of fluid in the downward direction through the wellbore and the valve once the valve is in the second configuration, which reduces the downward force on the plunger.

20. The method of claim 19, wherein the valve actuates from the second configuration into a third configuration in response to the upward force exceeding the reduced downward force, and wherein the plunger moves in the upward direction and forms the seal with the housing in the third configuration.
